(19) United States
(12) Patent Application Publication
(10) Pub. No.: US 2020/0156306 A1
(43) Pub. Date: May 21, 2020

(54) ORIENTED THERMALLY CONDUCTIVE DIELECTRIC FILM

(71) Applicant: 3M INNOVATIVE PROPERTIES COMPANY, St. Paul, MN (US)

(72) Inventors: Mario A. Perez, Burnsville, MN (US); Jeremy M. Higgins, Roseville, MN (US); Clint J. Novotny, Arlington, VA (US); Mitchell T. Huang, Austin, TX (US)

(21) Appl. No.: 16/632,970

(22) PCT Filed: Jul. 26, 2018
(86) PCT No.: PCT/IB2018/055615

§ 371 Date: Jan. 22, 2020

Related U.S. Application Data
(60) Provisional application No. 62/541,920, filed on Aug. 7, 2017.

(51) Int. Cl. B29C 55/12; C08K 3/22; C08K 7/18

(52) U.S. Cl. CPC B29C 55/12; C08K 3/22; C08J 2367/02; C08K 2003/2227; C08K 2201/005; C08K 7/18

(57) ABSTRACT

An oriented film includes, an orientated polyester layer, and alumina particles dispersed within the orientated polyester layer. The alumina particles are present in an amount from 20 to 40% wt of the orientated film. The alumina particles having a D99 value of 25 micrometers or less.

### BACKGROUND

Heat is an undesirable by-product in the operation of electrical devices, such as, motors, generators, and transformers. Elevated operating temperatures can reduce device reliability and lifetime. The dissipation of heat also imposes constraints on device design and hinder the ability to achieve higher power density devices. Electrical insulation materials typically have low thermal conductivity, which can limit heat dissipation in electrical devices.

Polyethylene terephthalate films are widely used as electrical insulation within motors, generators, transformers, and many other applications. For higher performance applications, where higher temperature and/or higher chemical resistance are needed, polyimide films are used.

### SUMMARY

The present disclosure relates to oriented thermally conductive dielectric films. In particular, the dielectric films are oriented thermoplastic films filled with alumina particles.

In one aspect, an oriented film includes, an orientated polyester layer, and alumina particles dispersed within the orientated polyester layer. The alumina particles are present in an amount from 20 to 40% wt of the orientated film. The alumina particles having a D₉₉ value of 25 micrometers or less.

In another aspect, an oriented film includes an orientated layer formed of polyethylene terephthalate or polyethylene naphthalate, and substantially spherically alumina particles dispersed in the orientated polyester layer. The alumina particles are present in an amount from 20 to 40% wt of the orientated film. The alumina particles have a D₉₉ value of 20 micrometers or less, or 15 micrometers or less, or 10 micrometers or less, and a median size value in a range from 1 to 7 micrometers, or from 1 to 5 micrometers, or from 1 to 3 micrometers.

In another aspect, a method includes dispersing alumina particles in a polyester material to form a filled polyester material. The alumina particles are present in the filled polyester material in an amount from 20 to 40% wt of the filled polyester material. The alumina particles have a D₉₉ value of 25 micrometers or less. Then the method includes forming a filled polyester layer from the filled polyester material and stretching the filled polyester layer to form an oriented filled polyester film. The oriented filled thermoplastic film has a thermal conductivity greater than 0.25 W/(m−K).

These and various other features and advantages will be apparent from a reading of the following detailed description.

### DETAILED DESCRIPTION

In the following detailed description, reference is made to the accompanying drawings that form a part hereof, and in which are shown by way of illustration several specific embodiments. It is to be understood that other embodiments are contemplated and may be made without departing from the scope or spirit of the present disclosure. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise.

As used in this specification and the appended claims, the term “or” is generally employed in its sense including “and/or” unless the content clearly dictates otherwise.

As used herein, “have”, “having”, “include”, “including”, “comprise”, “comprising” or the like are used in their open ended sense, and generally mean “including, but not limited to”. It will be understood that “consisting essentially of”, “consisting of”, and the like are subsumed in “comprising,” and the like.

“Polymer” refers to, unless otherwise indicated, polymers and copolymers (i.e., polymers formed from two or more monomers or comonomers, including terpolymers, for example), as well as copolymers or polymers that can be formed in a miscible blend by, for example, coextrusion or reaction, including transesterification, for example. Block, random, graft, and alternating polymers are included, unless indicated otherwise.

“Polyester” refers to a polymer that contains an ester functional group in the main polymer chain. Copolyesters are included in the term “polyester”.

“Semi-aromatic” polymer refers to a polymer that is not fully aromatic and contains aliphatic segments. Semi-aromatic polymers referred to herein are not capable of forming or exhibiting a liquid crystal phase.

The present disclosure relates to oriented thermally conductive dielectric films. In particular, the films are oriented thermoplastic film filled with alumina particles. The oriented thermoplastic film may be one or more polyesters or polyester copolymers that may be semi-aromatic and contain at least 20% wt. alumina, or in a range from 25% wt to 35% wt alumina. The alumina particles have a D₉₉ value of 25 micrometers or less, or 20 micrometers or less, or 15 micrometers or less, or 10 micrometers or less. The alumina particles may be spherical or substantially spherical. These oriented thermoplastic films filled with alumina particles may have a high mechanical toughness and thermal conductivity. The oriented alumina filled films described herein are unique because molecular orientation is imparted by stretching to enhance mechanical properties while minimally affecting thermal and electrical properties. The oriented high thermal conductivity films and sheets described herein may be formed via biaxial (sequential or simultaneous) or uniaxial stretching. Oriented films described herein have thermal conductivities (through the plane) greater than 0.25 W/(m-K) with dielectric or breakdown strength of at least 50 kV/mm, or at least 70 kV/mm, or at least 80 kV/mm. These films can be utilized in many areas of thermal management that lead to higher equipment efficiencies and lower operating temperatures with potentially higher power delivery per unit volume. While the present disclosure is not so limited, an appreciation of various aspects of the disclosure will be gained through a discussion of the examples provided below.

The oriented thermoplastic film described herein can be formed of any useful thermoplastic polymer material that can be molecularly orientated via stretching. The oriented thermoplastic film can be formed of polyphenylsulphone, polypropylene, polyester or fluoropolymers, for example. In many embodiments, the oriented thermoplastic film is formed of a polyester such as polyethylene terephthalate (PET) or polyethylene naphthalate (PEN) or copolymers thereof.

The polyester polymeric materials may be made by reactions of terephthalate dicarboxylic acid (or ester) with ethylene glycol. In some embodiments, the polyester is generally made by reactions of terephthalate dicarboxylic acid (or ester) with ethylene glycol and at least one additional comonomer that contributes branched or cyclic C₂-C₁₀ alkyl units.

Suitable terephthalate carboxylate monomer molecules for use in forming the terephthalate subunits of the polyester include terephthalate carboxylate monomers that have two or more carboxylic acid or ester functional groups. The terephthalate carboxylate monomer may include terephthalate dicarboxylic acid such as 2,6-terephthalate dicarboxylic acid monomer and isomers thereof.

The polyester layer or film may include a branched or cyclic C₂-C₁₀ alkyl unit that is derived from a branched or cyclic C₂-C₁₀ alkyl glycol such as neopentyl glycol, cyclohexanedimethanol, and mixtures thereof. The branched or cyclic C₂-C₁₀ alkyl unit may be present in the polyester layer or film in an amount less than 2 mol %, or less than 1.5 mol %, or less than 1 mol %, based on total mol % of ethylene and branched or cyclic C₂-C₁₀ alkyl units used to from the polyester material.

The polyester layer or film may be referred to as “semi-aromatic” and contain non-aromatic moieties or segments. In many embodiments the semi-aromatic polyester layer includes at least 5 mol % aliphatic segments or at least 10 mol % aliphatic segments or at least 20 mol % aliphatic segments or at least 30 mol % aliphatic segments. The polyester layer or film described herein may not exhibit or form a liquid crystal phase.

An oriented film may include an orientated polyester layer and alumina particles dispersed within or throughout the orientated polyester layer. The alumina particles form at least 20% wt. of the oriented film, or from 20 to 40% wt of the oriented film, or from 25 to 35% wt of the oriented film.

The alumina particles have a D₉₉ value of 25 micrometers or less, or 20 micrometers or less, or 15 micrometers or less, or 10 micrometers or less. The alumina particles have a median size value in a range from 1 to 7 micrometers, or from 1 to 5 micrometers, or from 1 to 3 micrometers. One method to determine particle size is described in ASTM Standard D4464 and utilizes laser diffraction (laser scattering) on a Horiba LA 960 particle size analyzer.

Substantially all the alumina particles are spherical or semi-spherical. Useful alumina particles are commercially available under the trade designation AY2-75 from Nippon Steel & Sumikin Materials Co. Hyogo, Japan. Useful alumina particles are commercially available under the trade designation Martoxid TM 1250 from Huber/Martinswerk, GmbH, Bergheim, Germany.

The alumina filler increases the thermal conductivity value of the thermoplastic layer it is incorporated into. The unfilled thermoplastic layer may have a through plane thermal conductivity value of 0.25 W(m-K) or less or 0.2 W/(m-K) or less or 0.15 W/(m-K) or less. The filled (with the thermally conductive alumina filler) thermoplastic layer has a thermal conductivity value of 0.25 W/(m-K) or greater, or 0.3 W/(m-K) or greater, or 0.35 W/(m-K) or greater. The thermally conductive filler may increase the thermal conductivity value of the thermoplastic layer by at least 0.1 W/(m-K) or at least 0.2 W/(m-K) or at least 0.3 W/(m-K) or at least 0.5 W/(m-K).

The oriented alumina filled thermoplastic films described herein may be referred to as a “dielectric” film. In many embodiments, the oriented alumina filled thermoplastic films described herein have a dielectric or breakdown strength of at least 50 kV/mm or at least 60 kV/mm or at least 70 kV/mm or at least 80 kV/mm or at least 90 kV/mm.

The oriented alumina filled thermoplastic films described herein may exhibit improved Graves tear properties as compared to similarly oriented thermoplastic films filled with other thermally conductive fillers. The oriented alumina filled thermoplastic films described herein may exhibit a Graves area per mil value of at least 50 (lbs*% displacement)/mil, or at least 75 (lbs*% displacement)/mil, or at least 90 (lbs*% displacement)/mil, or at least 100 (lbs*% displacement)/mil.

The thermally conductive and oriented thermoplastic films described herein may be formed by dispersing a thermally conductive alumina filler in a thermoplastic material to form a filled thermoplastic material and forming a filled thermoplastic layer from the filled thermoplastic material. The dispersing step may include dispersing homogeneous spherical alumina particles throughout the polyester material to form the filled thermoplastic material. The alumina particles form from 20 to 40% wt of the filled polyester material. The alumina particles have a D₉₉ value of 25 micrometers or less, or 20 micrometers or less, or 15 micrometers or less, or 10 micrometers or less.

Then the method includes stretching the filled thermoplastic layer to form an oriented filled thermoplastic film, the oriented filled thermoplastic film having a thermal conductivity greater than 0.25 W/(m-K). The stretching step biaxially orients the filled thermoplastic layer to form a biaxially oriented filled thermoplastic film. In some embodiments, the stretching step uniaxially orients the filled thermoplastic layer to form a uniaxially oriented filled thermoplastic film.

The stretching step may form an oriented (biaxial or uniaxial stretched) filled polyester film having a thickness in a range from 25 to 250 micrometers, or from 35 to 200 micrometers, or from 35 to 150 micrometers, or from 35 to 125 micrometers, and having a thermal conductivity value of 0.25 W/(m-K) or greater, or 0.3 W/(m-K) or greater, or 0.35 W/(m-K) or greater, and a dielectric or breakdown strength of at least 50 kV/mm, or at least 70 kV/mm, or at least 80 kV/mm.

The thermally conductive and oriented thermoplastic film can be stretched in one or orthogonal directions in any useful amount. In many embodiments the thermally conductive and oriented thermoplastic film can be stretched to double (2×2) or triple (3×3) a length and/or width of the original cast film or any combination thereof such as a 2×3, for example.

Even though the thermally conductive film is stretched to orient the film, voids in the final film are not present. Any voids that may be created during the stretching or orienting process can be filled be removed by heat treating. It is surprising that these thermally conductive film

The final thickness of the thermally conductive and oriented thermoplastic film can be any useful value. In many embodiments, final thickness of the thermally conductive and oriented thermoplastic film is in a range from 25 to 250 micrometers, or from 35 to 200 micrometers or from 35 to 150 micrometers or from 35 to 125 micrometers.

The thermally conductive and oriented thermoplastic film can be adhered to a non-woven fabric or material. The thermally conductive and oriented thermoplastic film can be adhered to a non-woven fabric or material with an adhesive material. The thermally conductive and oriented thermoplastic film and film articles described herein can be incorporated into motor slot insulation and dry type transformer insulation. The thermally conductive and oriented thermoplastic film may form a backing of a tape with the addition of an adhesive layer disposed on the thermally conductive and oriented thermoplastic film. The additional adhesive layer may be any useful adhesive such as a pressure sensitive adhesive.

Objects and advantages of this disclosure are further illustrated by the following examples, but the particular materials and amounts thereof recited in these examples, as well as other conditions and details, should not be construed to unduly limit this disclosure.

### EXAMPLES

All parts, percentages, ratios, etc. in the examples are by weight, unless noted otherwise. Solvents and other reagents used were obtained from Sigma-Aldrich Corp., St. Louis, Miss. unless specified differently.

### Materials

| Abbreviation | Description |
|---|---|
| R1 | Copolyester Laser + C 9921, available from DAK |
| | Americas LLC, Charlotte, NC. |
| F1 | FUS-SIL Silica-Silica, FUS-SIL 550. Ceradyne |
| | Inc. A 3M Company. Midway, TN. |
| F2 | AY2-75 spherical alumina, available from Available from |
| | Nippon Steel & Sumikin Materials Co. Ltd., Hyogo, JP. |
| F3 | Martoxid TM 1250, semi-spherical alumina available |
| | from Huber/Martinswerk, GmbH., Bergheim, GE. |

### Procedure for Making Cast Sheets

All cast sheets were made with an 18 mm twin screw extruder made by LEISTRITZ EXTRUSIONSTECHINK GMBH, Nuremberg, Germany and instrumented by Haake Inc (now ThermoScientific Inc.) and sold as a Haake Polylab Micro18 System. Screw speed was held at 350 RPM. Extrusion rates ranged from 50 to 75 grams per minute. All thermoplastics in pellet form were fed into the twin screw with a K-tron feeder model KCL24/KQX4 made by Ktron America, Pitman, N.J. Fillers were fed with a Techweigh volumetric feeder made by Technetic Industries, St. Paul, Minn. A 4 inch coat-hanger die was utilized for this purpose. Final sheet thicknesses in the range of 0.5 to 0.09 mm were obtained.

### Procedure for Batch Stretching Cast Sheets

Squares of 58×58 mm were cut from the original cast sheets. The squares were loaded and stretched using an Accupull biaxial film stretcher made by Inventure Laboratories Inc., Knoxville, Tenn. A temperature of 100 C was set in all zones of the machine unless mentioned otherwise. Films were stretched at speeds ranging from 2-25 mm/min. A preheat of 30 seconds was chosen. The post heat was varied from 30 to 90 seconds. During the post heat the film is clamped at the maximum stretch reached during the cycle.

### Tests

### Mechanical Tests

Graves tear: Graves tear tests were performed according to ASTM D 1004-13 Tear Resistance (Graves Tear) of Plastic Film and Sheeting. For our case, MD signifies that the specimens were made so that the tear propagates along the machine direction of the film. TD for a tear propagation along the transverse direction. These tests and the tensile tests were conducted in an Instron Universal Testing machine model 2511 using a 500 N load cell (Bighamton, N.J.).

### Particle Test

Scanning electron microscopy (SEM). SEM of powder samples was undertaken using a Hitachi TM3000 Tabletop SEM. Powder samples were cast onto carbon tabs (Pelco Tabs, distributed by Ted Pella, Inc.) affixed to sample holders specific to the instrument. Powder specimens were then sputter coated (Quorum Technologies SC7620, equipped with Au/Pd target) to prevent charging in the electron beam. All images were taken with a 15 kV acceleration voltage in COMPO mode of the quadrapolar BSE detector.

Particle size distribution: Size distributions were taken using a Horiba LA-950 laser diffraction particle size analyzer. The analysis cell was filled with 2-butanone, and the system was aligned and blanked before each new specimen. Powders were added directly to the cell under circulation until the instruments red light source indicated an absorbance of 0.8-0.85 relative to the blank. Repeated measurements were taken to ensure stable distribution after a short (1 min), medium power (7) sonication to better disperse the particles. Results were analyzed via the “standard” Mie calculation model with a volume based distribution. D99 refer to the size value where 99% of particles are less than that value.

### Thermal Tests

Thermal conductivity: Thermal conductivity was calculated from thermal diffusivity, heat capacity, and density measurements according the formula:

k=α·cₚ·ρ

where k is the thermal conductivity in W/(m K), α is the thermal diffusivity in mm²/s, cₚ is the specific heat capacity in J/K-g, and ρ is the density in g/cm³. The sample thermal diffusivity was measured using a Netzsch LFA 467 “HyperFlash” directly and relative to standard, respectively, according to ASTM E1461-13. Sample density was measured using a Micromeritics AccuPyc 1330 Pycnometer, while the specific heat capacity was measured using a TA Instruments Q2000 Differential Scanning calorimeter with Sapphire as a method standard.

### Electrical Tests

Dielectric strength: The dielectric breakdown strength measurements were performed according to ASTM D149-97a (Reapproved 2004) with the Phenix Technologies Model 6TC4100-10/50-2/D149 that is specifically designed for testing in the 1-50 kV, 60 Hz (higher voltage) breakdown range. Each measurement was performed while the sample was immersed in the fluid indicated. The average breakdown strength is based on an average of measurements up to 10 or more samples. For this experiment we utilized, as is typical, a frequency of 60 Hz and a ramp rate of 500 volts per second.

### Sample Preparation

Samples were prepared and tested using the appropriate materials and procedures listed above and noted in Table 1 for each sample.

### Results

Table 1 below shows that the Graves tear properties of spherical and semi-spherical alumina loaded samples are superior to non-spherical silica at the same weight %. Thermal conductivities are provided in Table 2. Dielectric strengths are provided in Table 3.

The Graves area for the alumina loaded compounds is higher than that of the controls and commonly used polyester film for these applications. The particle-matrix interface of composite materials is generally considered the weakest link in many composite systems as stress concentration, void formation, and cavitation processes are known to preferentially initiate at these interfaces.

Particles with round or spherical morphology helps to prevent stress concentration at surface asperities and enables more efficient flow characteristics in the melts. Choosing particle size distributions wherein all particles (i.e. the D99 or D100) are below ˜⅓ of the film thickness additionally limits the potential for defects associated with agglomerates or mismatches between film thickness and particle size.

TABLE 1
Graves tear properties of control and composite materials.

| | | | | | Graves | Graves | | | Graves | Graves area |
|---|---|---|---|---|---|---|---|---|---|---|
| | | | Graves | Graves | Max | Max Load | Graves | Graves | area per mil | SD per mil |
| | | Thickness | Max | Max Load | Load/mil | SD/mil | Area | Area SD | (lbs * %)/ | (lbs * %)/ |
| Lot | Stretch | (mil) | Load (lbf) | SD (lbf) | (lbf)/mil | (lbf)/mil | (lbs * %) | (lbs * %) | mil | mil |
| 30% F3 in | 2X MD | 3.5 | 9.8 | 2.5 | 2.8 | 0.7 | 354 | 116.5 | 101.1 | 33.3 |
| R1 | | | | | | | | | | |
| 30% F2 (30 | 2X MD | 2.8 | 8.1 | 1.2 | 2.9 | 0.4 | 285 | 74.55 | 101.8 | 26.6 |
| parts) & F3 | | | | | | | | | | |
| (70 parts) | | | | | | | | | | |
| in R1 | | | | | | | | | | |
| R1 | 2X MD | 3.5 | 7.6 | 2.1 | 2.2 | 0.6 | 300 | 49.2 | 85.7 | 14.1 |
| R1 | 2.5X MD | 1.5 | 4.7 | 2.2 | 3.1 | 1.5 | 196 | 130 | 130.7 | 86.7 |
| 30% F3 in | 25X MD | 1.5 | 4.6 | 0.31 | 3.1 | 0.2 | 142 | 33.2 | 94.7 | 22.1 |
| R1 | | | | | | | | | | |
| 30% F2 (30 | 2.5X MD | 1.33 | 5.4 | 0.4 | 4.1 | 0.3 | 157 | 36 | 118.0 | 27.1 |
| parts) & F3 | | | | | | | | | | |
| (70 parts) | | | | | | | | | | |
| in R1 | | | | | | | | | | |
| 30% F1 in | 2.5X MD | 2 | 5.3 | 0.7 | 2.7 | .4 | 25 | 16 | 12.5 | 8 |
| R1 | | | | | | | | | | |

TABLE 2
Thermal conductivity

| | | | | Thermal |
|---|---|---|---|---|
| | | Thick- | Thermal | Conductivity |
| | | ness | Conductivity | Uncertainty |
| Lot | Stretch | mm | W/m-K | W/m-K |
| 30% F3 in R1 | 2× | 0.11 | 0.36 | 0.03 |
| 30% F2 (30 parts) & | 2× | 0.10 | 0.33 | 0.03 |
| F3 (70 parts) in R1 | | | | |
| 30% F2 (30 parts) & | 2.5× | 0.06 | 0.29 | 0.05 |
| F3 (70 parts) in R1 | | | | |
| 30% F1 in R1 | 2× | 0.15 | 0.37 | 0.02 |

TABLE 3
Dielectric Strength

| | | | | Dielectric |
|---|---|---|---|---|
| | | Thick- | Dielectric | Strength |
| | | ness | Strength | Std Dev |
| Lot | Stretch | mm | kV/mm | kV/mm |
| 30% F3 in R1 | 2× | 0.12 | 84 | 7 |
| 30% F2 (30 parts) & | 2× | 0.15 | 73 | 14 |
| F3 (70 parts) in R1 | | | | |
| 30% F2 (30 parts) & | 2.5× | 0.08 | 102 | 10 |
| F3 (70 parts) in R1 | | | | |
| 30% F1 in R1 | 2× | 0.21 | 62 | 4 |

TABLE 4
Particle Size

| Material | F1 | F2 | F3 |
|---|---|---|---|
| Median Size (μm) | 9.77 | 5.33 | 1.65 |
| Mean (μm) | 10.79 | 5.67 | 2.00 |
| D10 (μm) | 5.41 | 3.20 | 0.26 |
| D90 (μm) | 17.19 | 8.58 | 4.43 |
| D99 (μm) | 29.04 | 2.67 | 7.33 |

Thus, embodiments of ORIENTED THERMALLY CONDUCTIVE DIELECTRIC FILM are disclosed.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof. The disclosed embodiments are presented for purposes of illustration and not limitation.

1. An oriented film comprising:
an orientated polyester layer; and
alumina particles dispersed within the orientated polyester layer and comprise from 20 to 40% wt of the orientated film, the alumina particles having a D₉₉ value of 25 micrometers or less.

2. The film according to claim 1, wherein the alumina particles have a D₉₉ value of 20 micrometers or less, or 15 micrometers or less, or 10 micrometers or less.

3. The film according to claim 1, wherein the alumina particles have a median size value in a range from 1 to 7 micrometers, or from 1 to 5 micrometers, or from 1 to 3 micrometers.

4. The film according to claim 1, wherein substantially all of the alumina particles are spherical or semi-spherical.

5. The film according to claim 1, wherein the orientated polyester layer comprises from 25 to 35% wt alumina particles.

6. The film according to claim 1, wherein the oriented film has a Graves area per mil value of at least 50 (lbs*% displacement)/mil, or at least 75 (lbs*% displacement)/mil, or at least 90 (lbs*% displacement)/mil, or at least 100 (lbs*% displacement)/mil.

7. The film according to claim 1, wherein the oriented film has a thickness in a range from 25 to 250 micrometers, or from 35 to 200 micrometers, or from 35 to 150 micrometers, or from 35 to 125 micrometers.

8. The film according to claim 1, wherein the oriented film has a thermal conductivity value of 0.25 W/(m-K) or greater, or 0.3 W/(m-K) or greater, or 0.35 W/(m-K) or greater.

9. The film according to claim 1, wherein the orientated polyester layer is formed from polyethylene terephthalate or polyethylene naphthalate.

10. The film according to claim 1, wherein the orientated polyester layer comprises biaxially orientated polyethylene terephthalate.

11. The film according to claim 1, wherein the oriented film has breakdown strength of at least 50 kV/mm, or at least 70 kV/mm, or at least 80 kV/mm.

12. An oriented film comprising:
an orientated polyester layer formed of polyethylene terephthalate or polyethylene naphthalate; and
substantially spherically alumina particles dispersed in the orientated polyester layer and comprising from 20 to 40% wt of the orientated film, the alumina particles having a D₉₉ value of 20 micrometers or less, or 15 micrometers or less, or 10 micrometers or less, and a median size value in a range from 1 to 7 micrometers, or from 1 to 5 micrometers, or from 1 to 3 micrometers.

13. The film according to claim 12, wherein the oriented film has a Graves area per mil value of at least 50 (lbs*% displacement)/mil, or at least 75 (lbs*% displacement)/mil, or at least 90 (lbs*% displacement)/mil, or at least 100 (lbs*% displacement)/mil.

14. The film according to claim 12, wherein the oriented film has a thickness in a range from 25 to 250 micrometers, or from 35 to 200 micrometers, or from 35 to 150 micrometers, or from 35 to 125 micrometers, and a thermal conductivity value of 0.25 W/(m-K) or greater, or 0.3 W/(m-K) or greater, or 0.35 W/(m-K) or greater.

15. The film according to claim 12, wherein the oriented film has breakdown strength of at least 50 kV/mm, or at least 70 kV/mm, or at least 80 kV/mm.

16. A method comprising:
dispersing alumina particles in a polyester material to form a filled polyester material, the alumina particles comprising from 20 to 40% wt of the filled polyester material, the alumina particles having a D₉₉ value of 25 micrometers or less;
forming a filled polyester layer from the filled polyester material;
stretching the filled polyester layer to form an oriented filled polyester film, the oriented filled thermoplastic film having a thermal conductivity greater than 0.25 W/(m-K).

17. The method according to claim 16, wherein the stretching step biaxially orients the filled polyester layer to form a biaxially oriented filled polyester film.

18. The method according to claim 16, wherein the stretching step forms an oriented filled polyester film having a thickness in a range from 25 to 250 micrometers, or from 35 to 200 micrometers, or from 35 to 150 micrometers, or from 35 to 125 micrometers, and a thermal conductivity value of 0.25 W/(m-K) or greater, or 0.3 W/(m-K) or greater, or 0.35 W/(m-K) or greater, and a breakdown strength of at least 50 kV/mm, or at least 70 kV/mm, or at least 80 kV/mm.

19. The method according to claim 16, wherein the oriented filled polyester film has a Graves area per mil value of at least 50 (lbs*% displacement)/mil, or at least 75 (lbs*% displacement)/mil, or at least 90 (lbs*% displacement)/mil, or at least 100 (lbs*% displacement)/mil.

20. The method according to claim 16, wherein the dispersing step comprises dispersing homogenous spherical alumina particles in a polyester material to form a filled polyester material.
